(19) United States
(12) Patent Application Publication
(10) Pub. No.: US 2004/0111366 A1
(43) Pub. Date: Jun. 10, 2004

(54) ACCRUAL SYSTEM, METHOD, PRODUCT, AND APPARATUS

(76) Inventor: Eric Schneider, University Heights, OH (US)

Correspondence Address: ERIC SCHNEIDER, 13944 CEDAR ROAD, # 258, UNIVERSITY HEIGHTS, OH, 44118, US

(21) Appl. No.: 10/604,598

(22) Filed: Aug. 1, 2003

Related U.S. Application Data
(60) Provisional application No. 60/319,448, filed on Aug. 3, 2002.

(51) Int. Cl. G06F 17/60; H04M 11/00

(52) U.S. Cl. 705/39; 455/406

(57) ABSTRACT

When at a first time, a non-monetary principal corresponding to a second time is received from one of a input, first data record, computer readable medium, machine readable code, internal automation, external automation, activation of a hyperlink, network resource redirection, and user interface element such as one of a browser location field, text box, command line, speech to text interface, optical recognition interface, and magnetic recognition interface, an accrued non-monetary interest can then be calculated from the non-monetary principal, the first time, and the second time.

### CROSS REFERENCE TO RELATED APPLICATIONS

This application claims the benefit of U.S. Provisional Application Serial No. 60/319,448 filed Aug. 3, 2002, by Schneider which is based on portions of a disclosure filed on Jul. 11, 2001, as Disclosure Document No. 496,673 under the Document Disclosure Program

### BACKGROUND OF INVENTION

1. Field of the Invention

This invention generally relates to accrual methods and systems, and more specifically relates to a method, product, system, and apparatus for non-monetary accrual.

2. Description of the Related Art

Launched in 1981, the AMERICAN AIRLINES AADVANTAGE program is generally acknowledged as the first true frequency-marketing program. The AADVANTAGE program was not merely a promotional fad applicable only within the travel industry, but a transitional event—tying new technology to many traditional marketing tactics.

By 1992, leading frequent-flyer program memberships had grown beyond 15 million travelers each, and were continuing to grow by more than 200,000 net new members every month. By 1994, airlines began to expand their offerings of miles for promotional use—beyond hotels, car rentals and credit cards—to phone companies, restaurants and to companies of all types for use as incentive rewards. Today, frequency-marketing programs are everywhere—in just about every industry imaginable. Most recently MilePoint.com, an Internet exchange site, allows members to convert their frequent traveler miles and points into a new online currency, MILEPOINT MONEY, and immediately go to any participating MILEPOINT merchant's online site to begin shopping. Merchandise or gift certificates that are currently offered on their site can be purchased using MILEPOINT MONEY as partial payment. Another company, NETCENTIVES, operates an online rewards program that allows consumers to earn points while shopping online and redeem them for merchandise and frequent-flyer miles.

Other reward accrual programs promote usage of a credit card account by rewarding a cardholder for account usage with either rebates or redeemable program points. As discussed a frequent flyer mile reward program is one example of a reward accrual program. Another example of a reward accrual program is the annual cash rebate reward offered by the issuer of the DISCOVER card. The issuer of the DISCOVER card offers an annual cash rebate based upon a card holder's annual charge volume.

Money is what people use to avoid barter—which is the direct trading of one good or service for another. There was a time when only governments could create money. They have long since delegated most of that responsibility to the banks—which create it in the form of mortgages or interest-bearing loans. They are helped by the credit card companies, which give the power to customers to create their own debts—and create their own money at the same time. In addition to points and miles, new currencies are on the horizon of exchange based on non-monetary amount types. For instance, Internet Service Providers (ISPs), telephone providers, and even pre-paid telephone cards are examples of how time is emerging as a new non-monetary amount type currency. The exchange of value on the Internet is not going to be necessarily tied to any particular piece of plastic or any particular piece of paper.

Though there is a convergence of different currencies emerging as digital money, these non-monetary systems (e.g., points, miles, time, etc.) remain primarily as closed systems serving as only a metaphor to money. For the sake of definition, a non-monetary system is a system having to do with the circulation of currency that is not legal tender issued by a sovereign power and a non-monetary amount is representative of any currency that is not legal tender. Legal tender is defined as any money that may be legally offered in payment of an obligation and that a creditor must accept. Though there have been some advances such as converting one non-monetary amount type into other non-monetary amount types, there are other aspects with respect to the accrual of money or legal tender that have not yet been applied to non-monetary systems of currency that is not considered legal tender.

### SUMMARY OF INVENTION

The present invention provides an accrual method for any non-monetary system that is not considered legal tender. The invention enables a non-monetary account such as a time account to earn time over a duration of time. The present invention includes an amount type converter for converting between different non-monetary amounts. The invention enables the processing of different non-monetary amount types such as an amount of product, amount of service, amount of reward, amount of points, amount of time, amount of distance, amount of volume, amount of mass, amount of bandwidth, and amount of energy. The present invention provides a notice that can be distributed via any communication medium for the purpose of educating customers and prospects alike of the non-monetary accrual method. The invention provides an account statement representative of an amount that is not legal tender and can be distributed via any medium to account holders with the addition of presenting earned accrual information.

In general, in accordance with an aspect of the present invention, an account statement includes a date, and an account balance corresponding to the date wherein at least a portion of the account balance includes an account interest and one of an account balance and account interest is representative of an amount that is not legal tender.

In accordance with another aspect of the present invention, an account statement includes an account rebate, a date, and an account balance corresponding to the date and the account rebate where one of an account balance and rebate is representative of an amount that is not legal tender.

In accordance with a alternate aspect of the present invention, a computer program product includes computer readable program code stored on a computer readable medium, the program code adapted to one of a generate, store, access, create, update, append, report, print, overwrite, send, forward, and distribute an account statement having a date and an account balance corresponding to the date where at least a portion of the account balance includes an account interest and one of an account balance and account interest is representative of an amount that is not legal tender.

In accordance with yet another aspect of the present invention, in a device having access to one of a memory and storage with a program stored therein, the program adapted to generate an amount, a method includes receiving at a first time, a first amount corresponding to a second time, and generating a second amount from the first amount, the first time, and the second time, wherein the first amount is a first non-monetary amount and the second amount is a second non-monetary amount.

In accordance with additional aspects of the present invention, an apparatus and/or system which implements substantially the same functionality in substantially the same manner as the methods described above is provided.

In accordance with yet other additional aspects of the present invention, a computer-readable medium that includes computer-executable instructions may be used to perform substantially the same methods as those described above is provided.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### BRIEF DESCRIPTION OF DRAWINGS

FIG. 1a is an illustration of an account statement that can be distributed via any medium to customers with the addition of presenting earned accrual information in accordance with the present invention.

FIG. 1b is an illustration of a notice that can be distributed via any communication medium for the purpose of educating customers and prospects alike of the non-monetary accrual method in accordance with the present invention.

FIG. 1c is an illustration of an ISP account statement in accordance with the present invention.

FIG. 1d is an illustration of an electric utility billing account statement in accordance with the present invention.

FIG. 1e is an illustration of an airline miles account statement in accordance with the present invention.

FIG. 1f is an illustration of an gas utility account statement in accordance with the present invention.

FIG. 1g is an illustration of an rewards account statement in accordance with the present invention.

FIG. 1h is an illustration of an beverage bottle account statement in accordance with the present invention.

FIG. 2a illustrates an exemplary system for providing a distributed computer system in accordance with the present invention.

FIG. 2b illustrates a block diagram of a computing device in accordance with the present invention.

FIG. 2c is an illustration of an exemplary table having data elements of an amount type converter in accordance with the present invention.

FIG. 2d is an illustration of an exemplary table having data elements of a client account database in accordance with the present invention.

FIG. 2e is an illustration of a client account database having data elements representative of different account types in accordance with the present invention.

FIG. 3a is a flow chart illustrating the steps performed for generating an accrual amount in accordance with the present invention.

FIG. 3b is a flow chart illustrating the steps performed for generating an accrual of time in accordance with the present invention.

FIG. 3c is a flow chart illustrating the steps performed for generating an accrued interest in accordance with the present invention.

FIG. 4 is a flow chart illustrating the steps performed for receiving a request to access an account in accordance with the present invention.

FIG. 5a is a flow chart illustrating the steps performed for generating an accrued amount from a data record in accordance with the present invention.

FIG. 5b is a flow chart illustrating the steps performed for generating a new data record having an accrued amount in accordance with the present invention.

FIG. 6a is a flow chart illustrating the steps performed when receiving amount related information from a variety of input sources in accordance with the present invention.

FIG. 6b is a flow chart illustrating the steps performed for generating an interest in accordance with the present invention.

### DETAILED DESCRIPTION

The present invention will now be described with reference to the drawings, wherein like reference numerals are used to refer to like elements throughout.

As defined in Webster's Dictionary, an “interest” is a “money paid for the use of money”. However, the term “interest” or more specifically “account interest” can be defined with respect to the present invention to be inclusive of the following; “money paid for the use of an amount that is not legal tender”, “an amount that is not legal tender paid for the use of money”, and “an amount that is not legal tender paid for the use of an amount that is not legal tender”. The context of the term “use” is applicable to money or an amount that is not legal tender that has been either saved or spent, deposited or withdrawn, etc.

An account statement having an account balance can be adjusted or modified to include an account interest based on account usage or lack thereof which is representative of an amount that is not legal tender. In a preferred aspect of the present invention, such an account statement can be that of a phone bill, for example. Included in the phone bill is an account balance having an amount type measured in the number of phone minutes used and/or unused by an account holder during a given period of service. An account interest corresponding to the account balance is included in the phone bill which reflects additional phone minutes earned by the account holder. As a result, the account holder has earned additional time over a duration of time.

It can be appreciated by one of ordinary skill in the art that the present invention is applicable across numerous industries having account statements with other amount types including but not limited to an amount of product, amount of service, amount of reward, amount of points, amount of distance, amount of light, amount of storage, amount of volume, amount of mass, amount of bandwidth, and amount of energy. For instance an electric bill can reflect an interest earned measured in kilowatt hours, an airline reward program can reflect an interest earned measured in points or miles, a bill from an ISP can include an interest earned measured in Megabytes of storage and so forth.

Account types can be combined for instance an amount of density can be determined by the relationship of an amount of mass over volume or an amount of velocity can be determined by the relationship of an amount of distance over time. Furthermore, amount types can be combined in any combination and reflect in an account statement. This would enable an account holder to earn interest measured in airline miles based on the usage of 1,000 minutes of phone time, for example. Amount type conversion is important to enable unlikely partnerships to develop. For instance, an ISP can venture with a company managing an airline mile program to enable ISP account holders to earn flyer miles based on the amount of phone minutes used during an account period.

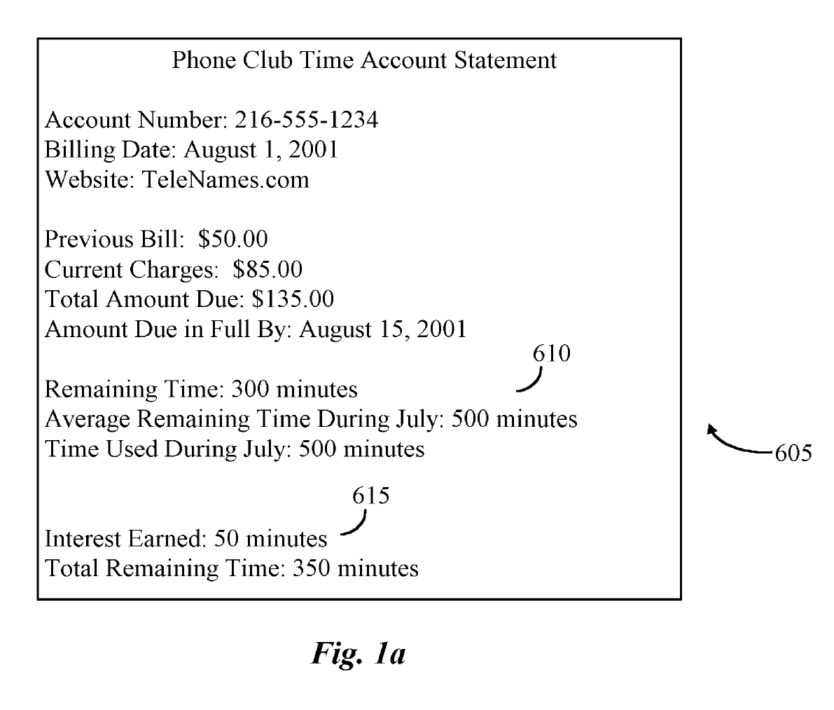

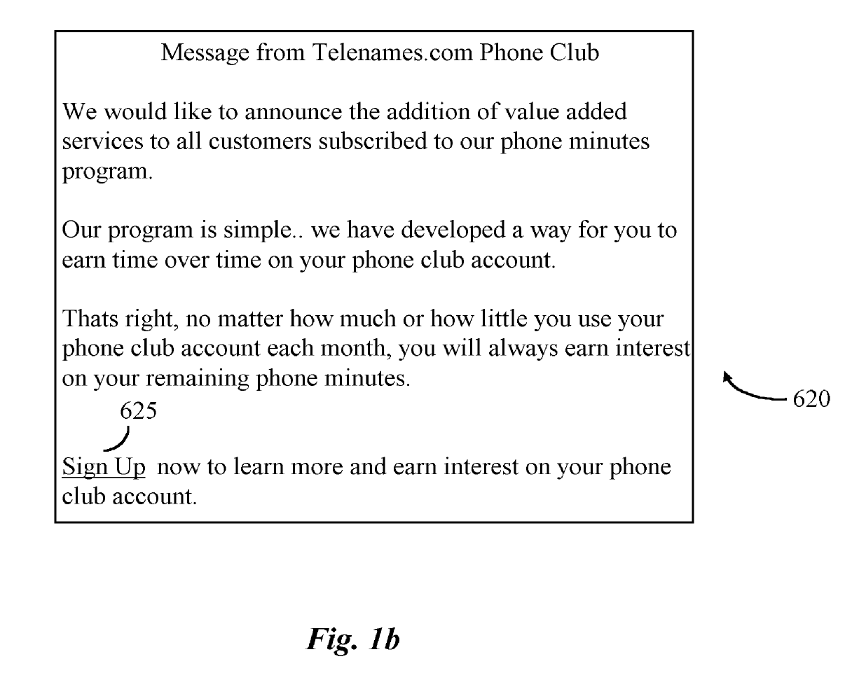

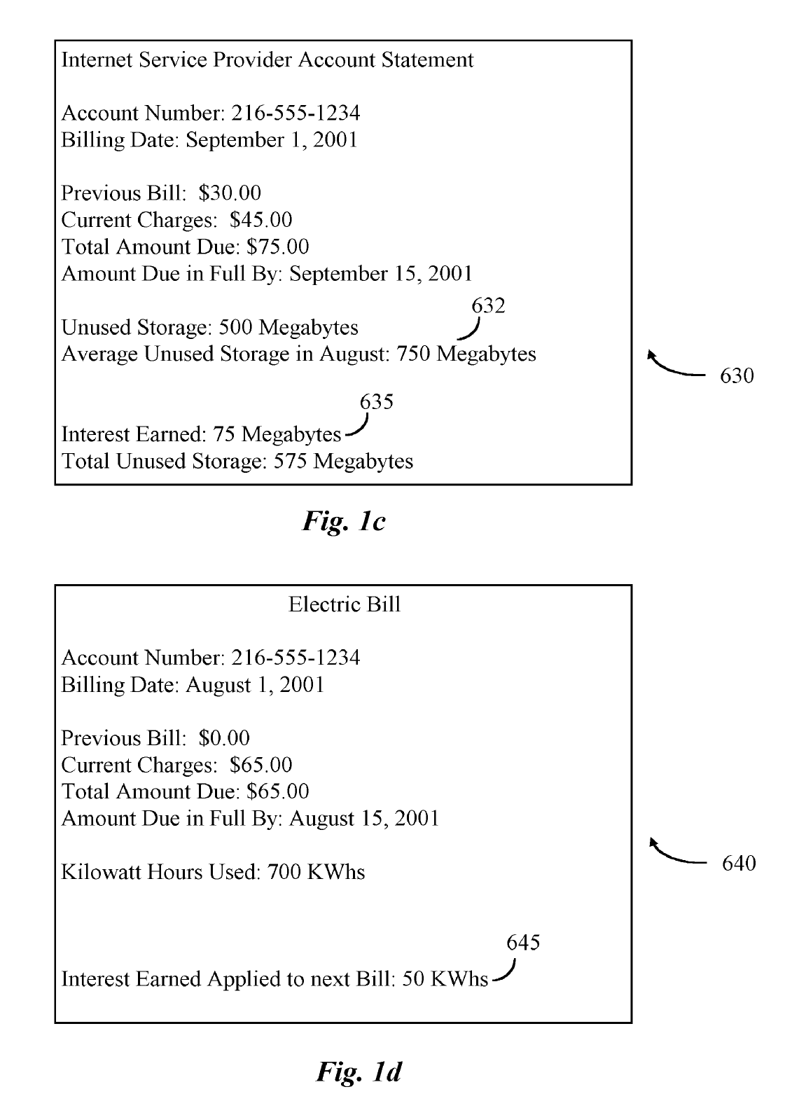

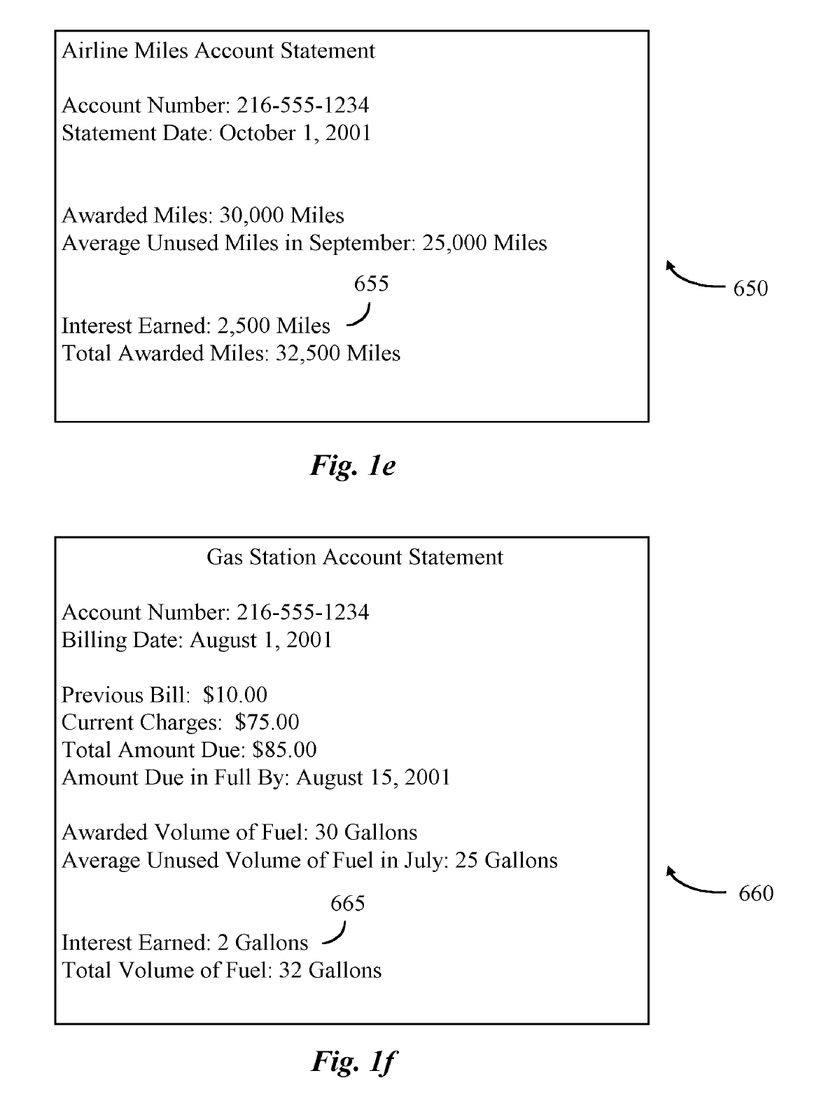

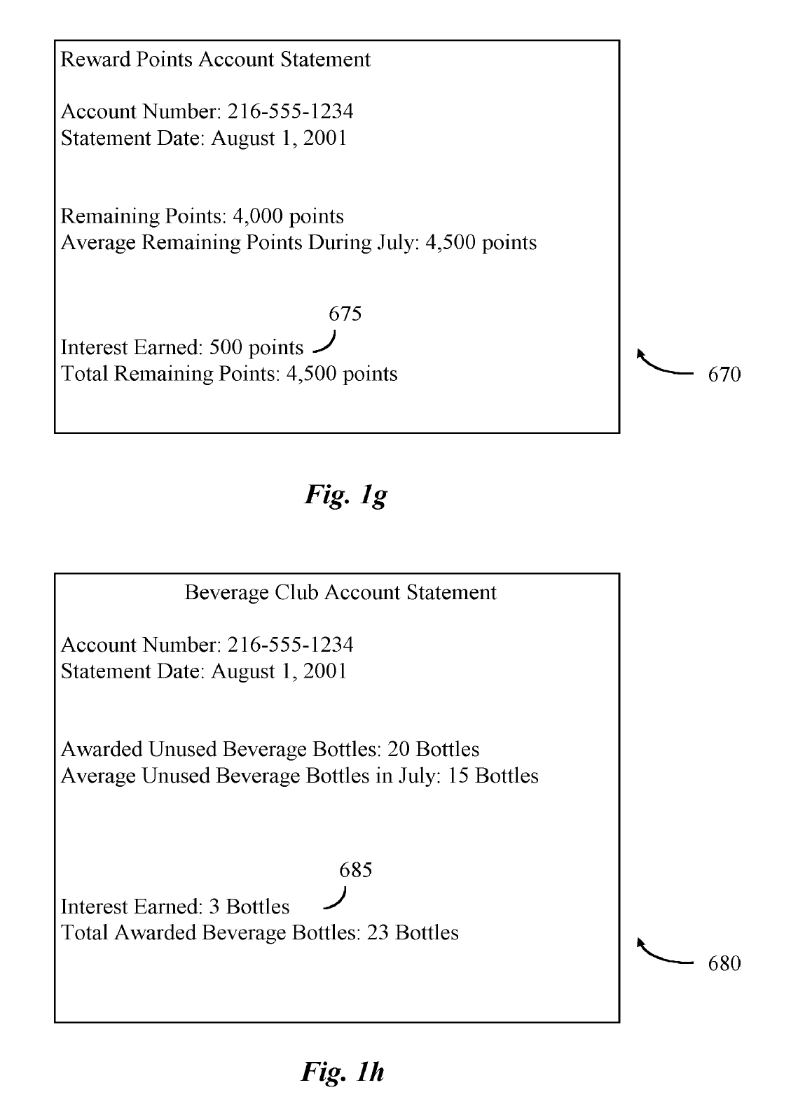

FIG. 1a is an illustration of an account statement that can be distributed via any medium (e.g., postal mail, Internet, etc.) to customers with the addition of presenting earned accrual information in accordance with the present invention. Though such a notice can be provided by many different service providers which manage many different non-monetary amount types, an account statement 605 similar to the present illustration in particular, can be sent via e-mail, postcard, postal mail, telephone, Instant Message (IM), and the like by a phone provider to a phone customer. Portions of such an account statement 605 can include an account number, billing date, due date, current charges, amount due, time usage 610 (e.g., remaining time, average remaining time during billing period, and time used during billing period), interest earned 615, total remaining time, and the like.

FIG. 1b is an illustration of a notice that can be distributed via any communication medium for the purpose of educating customers and prospects alike of the non-monetary accrual method in accordance with the present invention. A notice 620 can be provided by many different service providers which manage many different non-monetary amount types. Such a notice 620 similar to the present illustration in particular, can be sent via e-mail, postcard, postal mail, telephone, IM, or included with a billing statement and the like by a phone provider to a phone customer or prospect. In the case of an electronic transmission of such a notice such as via e-mail, banner ad, advertising pop-up window, and the like, a hyperlink 625 can be included for the phone customer or prospect to access a network resource for learning more about how interest in the form of phone minutes can be earned on an an account or how to sign up with such an offering/service.

FIG. 1c is an illustration of an ISP account statement in accordance with the present invention. An ISP account statement 630 can be sent via e-mail, postcard, postal mail, telephone, IM, and the like by an ISP to an ISP customer. Portions of such an account statement 630 can include an account number, billing date, due date, current charges, amount due, storage usage 632 (e.g., unused storage, average unused storage during billing period, and storage used during billing period), interest earned 635, total unused storage, and the like.

FIG. 1d is an illustration of an electric utility billing account statement in accordance with the present invention. An electric utility billing account statement 640 can be sent via e-mail, postcard, postal mail, telephone, IM, and the like by an electric company to a customer. Portions of such an account statement 640 can include an account number, billing date, due date, current charges, amount due, electricity usage (e.g., amount of electricity used/saved during billing period, etc.), interest earned 645, total electricity used, and the like.

FIG. 1e is an illustration of an airline miles account statement in accordance with the present invention. An airline miles account statement 650 can be sent via e-mail, postcard, postal mail, telephone, IM, and the like by an airline company to a airline miles customer. Portions of such an account statement 650 can include an account number, billing date, due date, current charges, amount due, miles traveled and usage (e.g., unused miles, average unused miles during billing period, and miles traveled during billing period), interest earned 655, total unused miles, and the like.

FIG. 1f is an illustration of a gas station account statement in accordance with the present invention. A gas station account statement 660 can be sent via e-mail, postcard, postal mail, and the like by a gas station account provider to a gas station customer. Portions of such an account statement 660 can include an account number, billing date, due date, current charges, amount due, storage usage (e.g., unused storage, average unused storage during billing period, and gas used during billing period), interest earned 665, total unused gas, and the like.

FIG. 1g is an illustration of a rewards account statement in accordance with the present invention. An rewards account statement 670 can be sent via e-mail, postcard, postal mail, telephone, IM, and the like by a rewards account provider to a rewards customer. Portions of such an account statement 670 can include an account number, billing date, due date, current charges, amount due, rewards usage (e.g., unused rewards, average unused rewards during billing period, and rewards used during billing period), interest earned 675, total unused rewards, and the like.

FIG. 1h is an illustration of a beverage bottle account statement in accordance with the present invention. A beverage bottle account statement 680 can be sent via e-mail, postcard, postal mail, telephone, IM, and the like by a beverage bottle account provider to a beverage bottle customer. Portions of such an account statement 680 can include an account number, billing date, due date, current charges, amount due, bottle usage (e.g., unused bottles, average unused bottles during billing period, and bottles used during billing period), interest earned 685, total unused bottles, and the like.

Account statements as illustrated in FIGS. 1c-1h serve as only a few examples of how an aspect of the present invention can be used by account providers across many industries. The beverage bottle example, is representative of an amount of product. Other beverages can include bottled water, soda cans, beer kegs, and milk cartons, for example. Other products can include food (e.g., meal plan, lunch card), commodities, any item with a UPC code or merchant identifier, and the like. In turn, such account statements can also be representative of an amount of service (e.g., auto shop can measure interest earned on an amount of auto services, a massage therapist can measure interest earned in the number of massages given to the client). Account statements can be provided by account providers to account holders either periodically, as part of an account transaction (e.g., sale, return, refund, exchange, deposit, withdrawal, etc.) or upon request by the account holder or any authorized user.

Such an accrual system can particularly be easily adapted to be operatively associated with any type of pre-paid account statement system with one of an account balance and account interest measured as any amount that is not legal tender. Moreover, the account interest can also be representative of an amount that is the absolute value corresponding to the difference between a starting account balance and an ending account balance during an account period. By using an absolute value, the account interest can be earned regardless or whether there is an increase or decrease in the account balance. An account interest that is earned based on a decreased principal can also be called an “account rebate”.

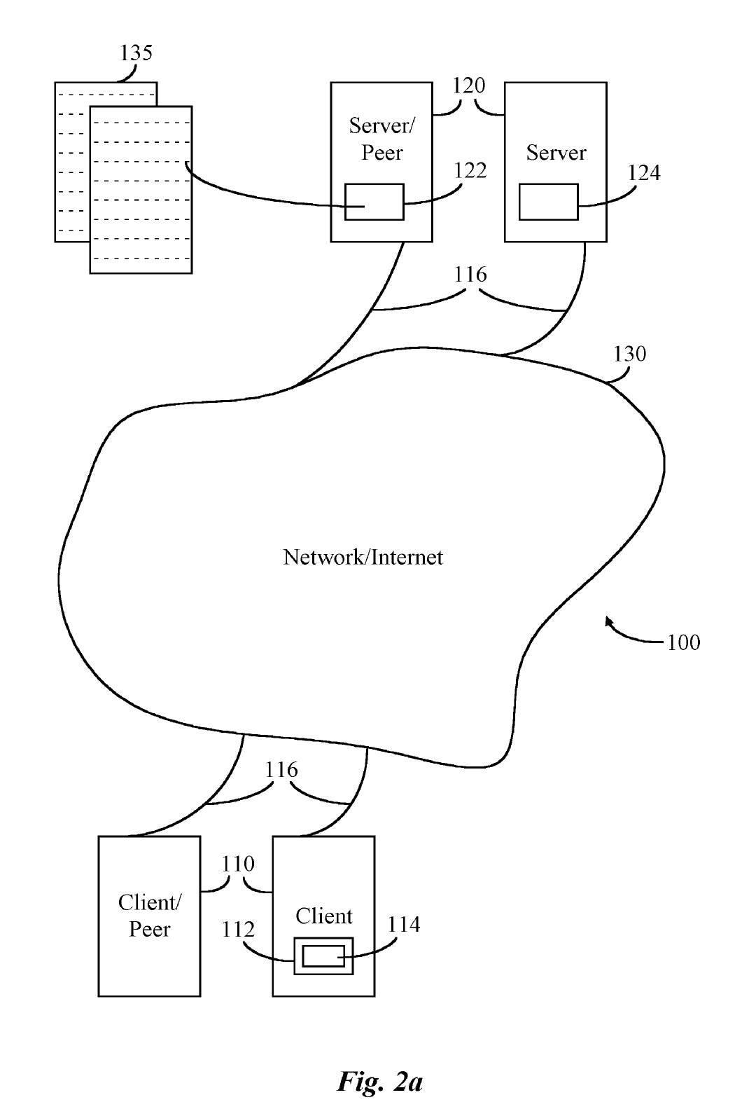

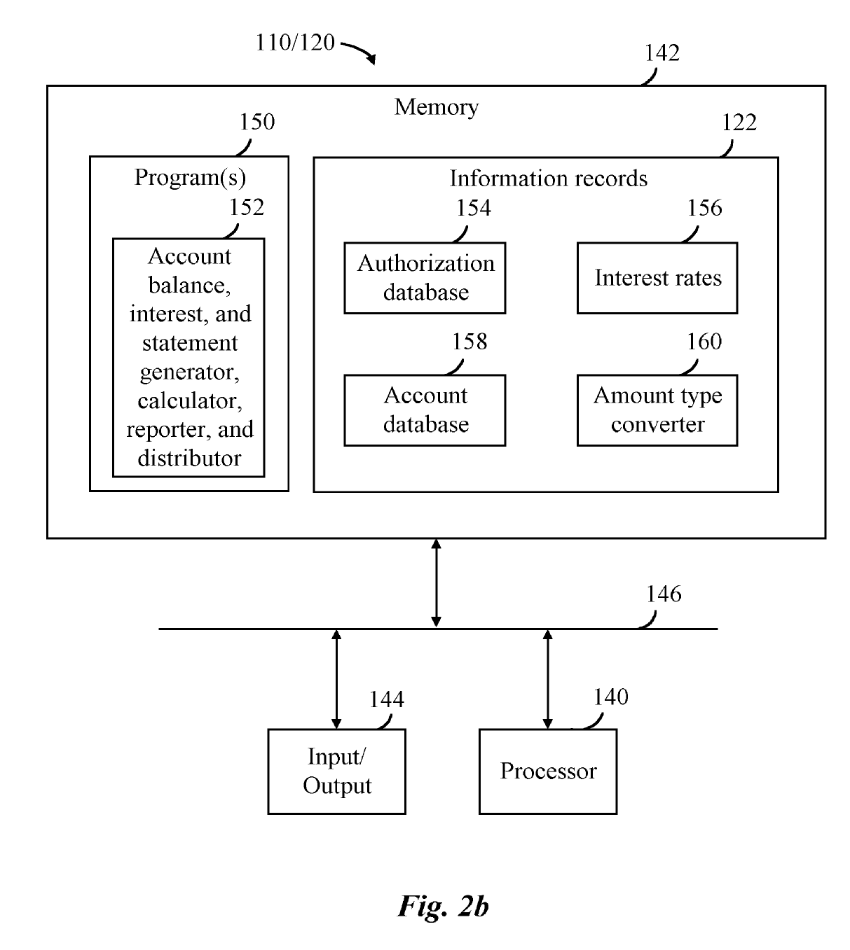

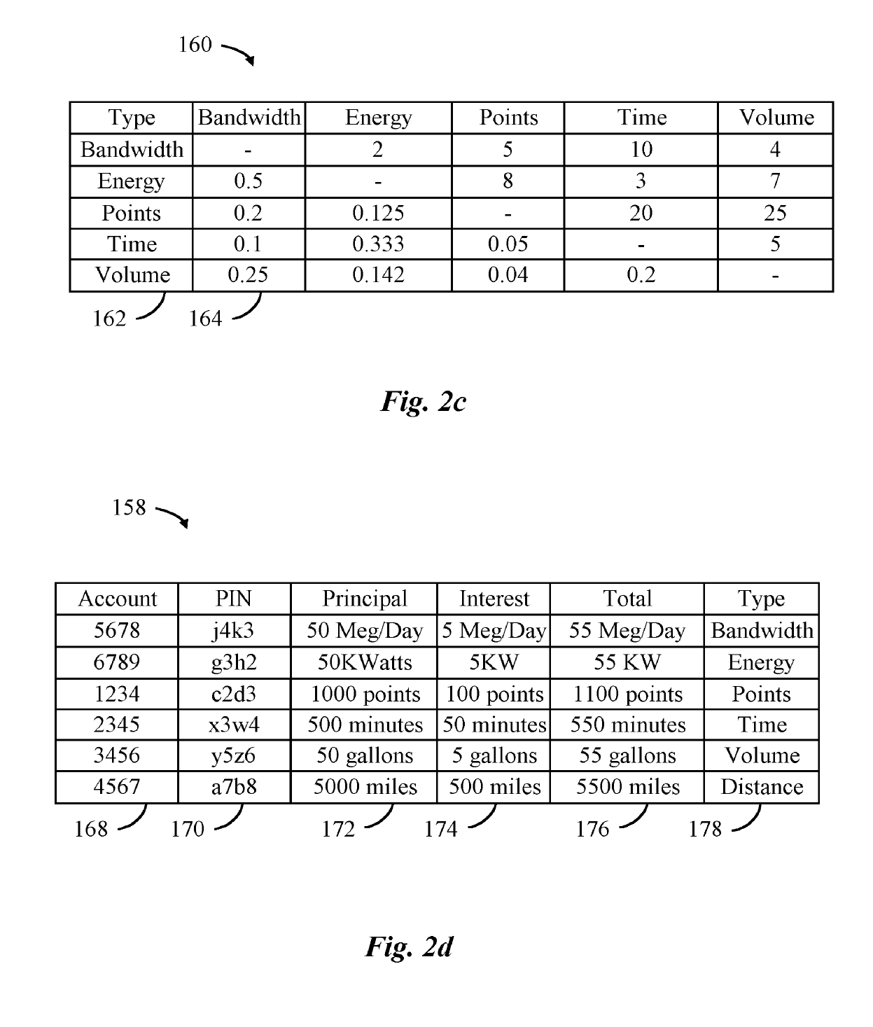

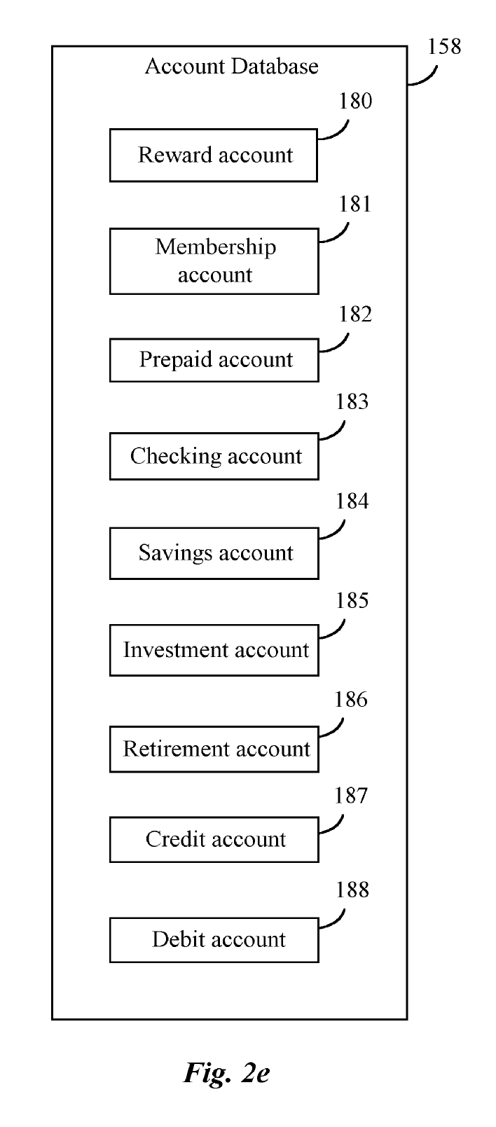

A typical computing device can include a controller, memory, and program which can be used to generate, store, access, create, update, append, report, print, overwrite, send, forward, and distribute a non-legal tender account statement having an earned interest. A separate program having an “account interest module” can be distributed and used by a computing device to upgrade or operate in conjunction with an existing “account statement module”. A computing device can be adapted to further communicate with other computing devices via a network as will be shown in FIG. 2a.

FIG. 2a is an illustration of a distributed computer system 100 that can include client computers (e.g., network access apparatus) 110 connected to server computers 120 via a network 130. Client computers 110 allow users access to the network 130. The network 130 may use Internet communications protocols to allow clients 110 to communicate with servers 120. The network access apparatus 110 can include a modem or like transceiver (not shown) to communicate with the electronic network 130. The modem may communicate with the electronic network 130 via a line 116 such as a telephone line, an ISDN line, a coaxial line, a cable television line, a fiber optic line, or a computer network line. Alternatively, the transceiver can wirelessly communicate with the electronic network 130. The electronic network 130 may be accessed via an on-line service, an Internet service provider, a local area network service, a wide area network service, a cable television service, a wireless data service, an intranet, a virtual private network, a peer-to-peer network, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems. It is noted that the network access apparatus 110 may have a variety of forms, including but not limited to, a general purpose computer, a network computer, a network television, an internet television, a set top box, a web-enabled telephone, an internet appliance, a portable wireless device, a television receiver, a game player, a video recorder, and/or an audio component, for example.

Each client computer 110 typically includes one or more processors, memories, and input/output devices. An input device may be any suitable device for the user to give input to client computer 110, for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye tracking device, or any MIDI device may also be used. A display device may be any suitable output device, such as a display screen, text-to-speech converter, printer, plotter, fax, television set, or audio player. Although the input device is typically separate from the display device, they could be combined; for example: a display with an integrated touchscreen, a display with an integrated keyboard, or a speech-recognition unit combined with a text-to-speech converter.

The servers 120 may be similarly configured. However, in many instances server sites include many server computers 120, perhaps connected by a separate private network. In fact, the network 130 can include hundreds of thousands of individual networks of computers. Although the client computers 110 are shown separate from the server computers 120, it should be understood that a single computer may perform the client and server roles. Those skilled in the art will appreciate that the distributed computer environment 100 is intended to be merely illustrative. The present invention may also be practiced in other computing environments. For example, the present invention may be practiced in multiple processor environments wherein the client computer includes multiple processors. Moreover, the client computer need not include all of the input/output devices as discussed above and can also include additional input/output devices. Those skilled in the art will appreciate that the present invention may also be practiced via Intranets and more generally in distributed environments in which a client computer requests resources from a server computer.

During operation of the distributed system 100, users of the client computers 110 may desire to access information records 122 stored by the servers 120 while utilizing, for example, the World-Wide-Web (WWW). Furthermore, such server systems 120 can also include one or more search engines 124. The records of information 122 may be in the form of Web pages 135. The pages 135 can be data records including as content plain textual information, or more complex digitally encoded multimedia content, such as software programs, graphics, audio signals, videos, and so forth. It should be understood that although this description focuses on locating information on the World-Wide-Web, the system may also be used for locating information via other wide or local area networks (WANs and LANs), or information stored in a single computer using other communications protocols.

The clients 110 may execute Web browser programs 112, such as NETSCAPE NAVIGATOR or MICROSOFT INTERNET EXPLORER to locate the web pages 135. The browser programs 112 enable users to enter web addresses of specific Web pages 135 to be retrieved. Typically, the address of a Web page is specified as a Uniform Resource Identifier (URI) or more specifically as a Uniform Resource Locator (URL). In addition, when a page has been retrieved, the browser programs 112 may provide access to other pages or records by “clicking” on hyperlinks, also called links, to previously retrieved Web pages. Such links may provide an automated way to enter the URL of another page, and to retrieve that page.

Point-of-sale (POS) systems can be considered a computing device 110/120, which has become common for transacting business between commercial retailers and consumers. Essentially, a POS system (not shown) comprises one or more controllers connected to a plurality of POS computer terminals, such as cash register terminals. The cash register terminals are in turn connected to one or more peripheral devices that operate with the terminals. Such POS terminals often keep a record of the transactions in memory. Periodically the terminal is connected via data line to a computer called a settlement host, which receives a record of all the transactions that have been conducted. The settlement host operates to make sure that the merchant's account is properly credited for all of the transactions that have been carried out at the terminal.

Electronic credit and debit card terminals can also be considered a computing device 110/120, which facilitate the processing of debit and credit card transactions. Merchants generally have these terminals at a point of sale of goods or services. Such terminals are connected through telephone or other data lines to computer networks, which process and keep accounts of transactions. When a consumer purchases goods or services at a point of sale the consumer's account may be charged if a credit card is used and the merchant's account may be credited. Similarly, if a debit card is used to pay for the purchase, the consumer's account is debited for the amount of the purchase and the merchant's account is credited.

The vast majority of credit and debit cards in use in the United States today contain information on the customer account associated with the card. One way in which account information is generally provided is by encoding the account information on a magnetic stripe on the back of the card. The magnetic stripe may have up to three data bearing tracks that include data representative of the customer's account number, name and other data.

In recent years, integrated circuit cards have been developed. These cards are often referred to as “smart cards”. Integrated circuit cards are similar to conventional debit and credit cards, except that they also include an integrated circuit chip. The integrated circuit chip is used to store data related to the customer and his or her account. The integrated circuit chip often includes encryption programs and stored data, which are used to correlate card information with a Personal Identification Number (PIN) which a customer may input in a transaction terminal. This correlation is used to provide authentication that the bearer is the proper user of the card.

FIG. 2b illustrates a block diagram of a computing system having a storage device such as memory 142 in operative association with a processor 140 and input/output devices 144 via at least one data bus 146. Such a computing system can operate in a self-contained or stand-alone capacity or as a client 110 and/or server 120 computing system(s). Stored in memory 142 may be programs/scripts/modules 150, and information records 122 having any combination of exemplary content such as lists, files, and databases. Such programs/scripts/modules 150 can include an account balance/interest/statement generator/calculator/reporter/distributor 152. Such information records 122 can include for example: authorization database 154, table of interest rates 156, client account database 158, and an amount type converter 160. For instance, whenever an account request is made, a non-monetary account interest, account balance, and account statement can be calculated, generated, and reported by consulting account, interest rate, type converter data tables in order to provide results if need be to the requester. These programs and information records are further introduced and discussed in more detail throughout the disclosure of this invention.

FIG. 2c is an illustration of an exemplary table having data elements of the amount type converter 160 in accordance with the present invention. The amount type converter 160 can include data elements 164 having a variety of different values, ratios, factors, weights, and exchange rates with respect to different amount type data elements 162. Such data values can be updated in real time responsive to recording changes in market conditions (not shown) such as the prime interest rate, stock prices, futures, commodities, oil prices, gas prices, utility prices, etc.

FIG. 2d is an illustration of an exemplary table having data elements of a client account database in accordance with the present invention. A client account database 158 can include data elements indicative of account number/account type 168, PIN code/password 170, principal amount 172, interest values (interest type/interest rate) 174, total amount 176, and amount type information 178. Other data elements (not shown) can include time values of withdrawals and deposits, exchange rates, conversion tables, or any other data element that can be used to manage a non-monetary accrual account database.

FIG. 2e is an illustration of an client account database 158 having data elements representative of many non-monetary account types in accordance with the present invention. Such account types can include reward account 180, membership account 181, prepaid account 182, checking account 183, savings account 184, investment account 185, retirement account 186, credit account 187, and debit account 188.

When accounts and/or data records of non-monetary units are retrieved either periodically or in response to a transaction or user request, there are no such known methods, products, and devices for treating a retrieved non-monetary amount as a principal capable of bearing a non-monetary interest amount over time. For example, a phone subscriber having an account with 1,000 minutes of calling time can benefit from the present invention with the ability of accruing time over a duration of time. In one embodiment, a non-monetary account can be used as an interest bearing non-monetary account. The interest period could be 6% per month and applied as simple interest, for example. After one month, a phone subscriber account having on average 1,000 remaining minutes can bear an extra 60 minutes of phone time for the subscriber at a later date. In turn, the account balance can instead reflect that a 1,000 phone minutes had been used during the account period. Rather than earning −60 minutes of additional phone time, an aspect of an account interest formula can be adjusted by its absolute value enabling the account holder to earn 60 minutes of phone time regardless of whether the principal of the account has been saved, used, or spent.

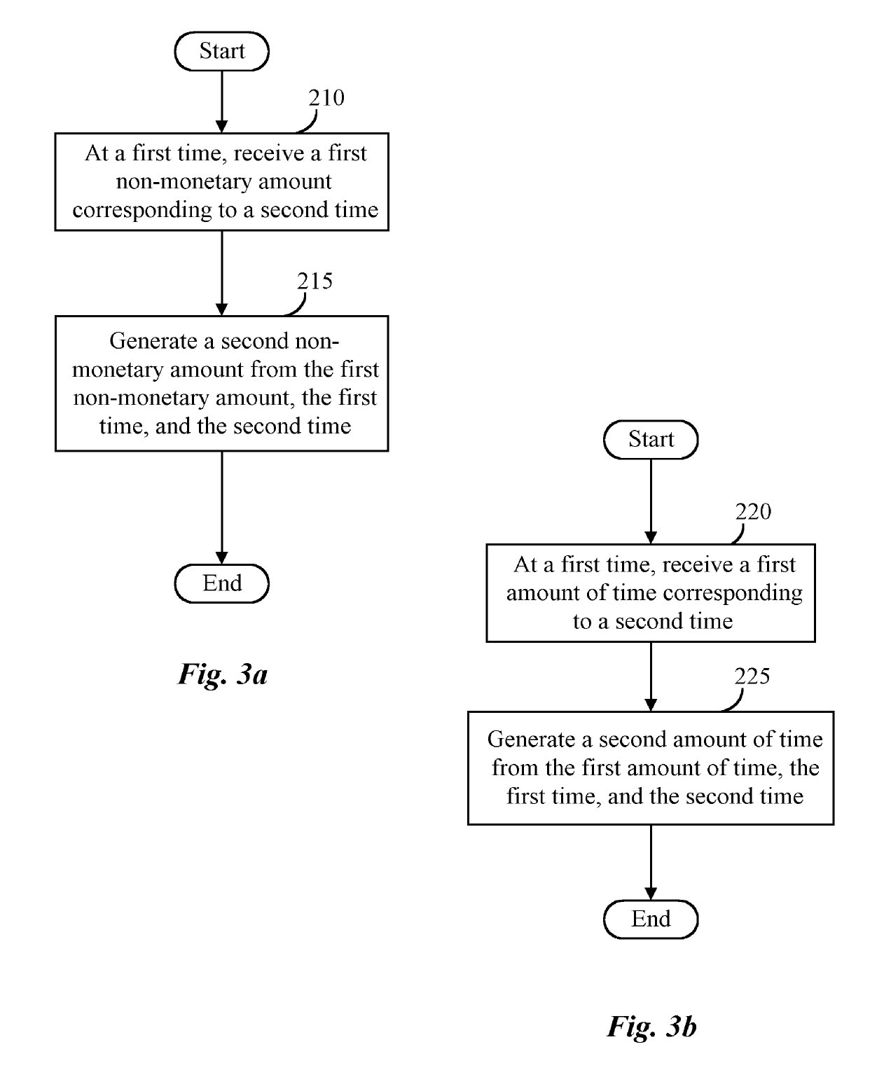

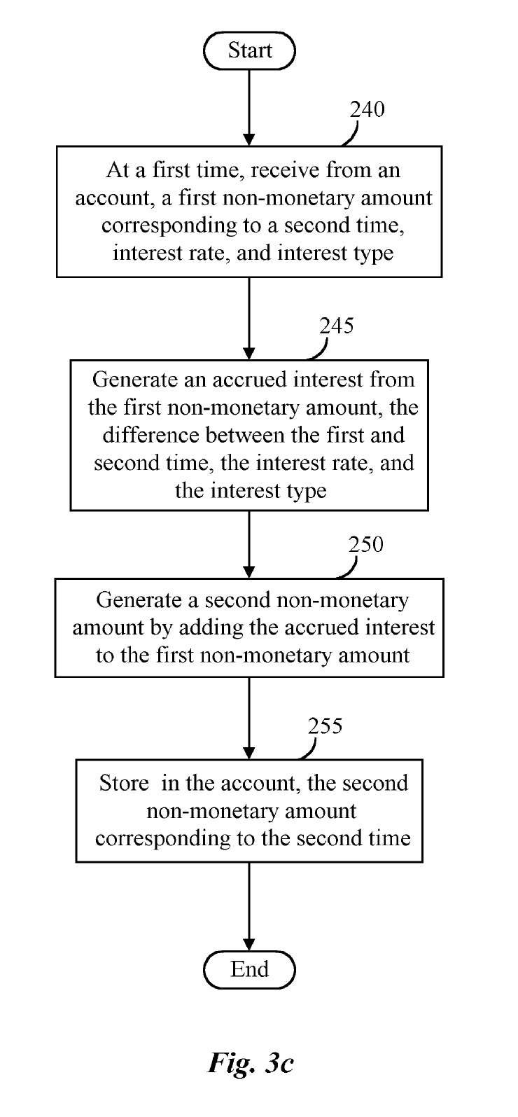

FIG. 3a is a flow chart illustrating the steps performed for generating an accrual amount in accordance with the present invention. When at a first time, a first non-monetary amount corresponding to a second time is received in step 210, a second non-monetary amount can then be generated in step 215 from the first non-monetary amount, the first time, and the second time. For instance, when an account holder makes a request for account information, a first amount corresponding to an earlier date is accessed from the account holder's account information and a second amount is calculated from the first amount based on the duration between the earlier retrieved time and the time of the account holder's request.

FIG. 3b is a flow chart illustrating the steps performed for generating an accrual of time in accordance with the present invention. When at a first time, a first amount of time corresponding to a second time is received in step 220, a second amount of time can then be generated in step 225 from the first amount of time, the first time, and the second time. These steps are similar to the steps presented in FIG. 3a but are more specific in the sense that the first and second amounts are relate to an amount of time. These steps can be performed by a program 150 in order to generate at least a portion of an account statement such as the account statement 605 illustrated in FIG. 1a.

FIG. 3c is a flow chart illustrating the steps performed for generating an accrued interest in accordance with the present invention. When at a first time, a first non-monetary amount corresponding to a second time, interest rate, and interest type is received in step 240 from an account, an accrued interest can then be generated in step 245 from the first non-monetary amount, the difference between the first time and second time, the interest rate, and the interest type. A second non-monetary amount can then be generated in step 250 by adding the accrued interest to the first non-monetary amount. The second non-monetary amount corresponding to the second time can then be stored in the account in step 255. Similar to the steps presented in FIGS. 3a and 3b, the difference between the first and second amount equals an earned account interest which is representative of any amount that is not legal tender.

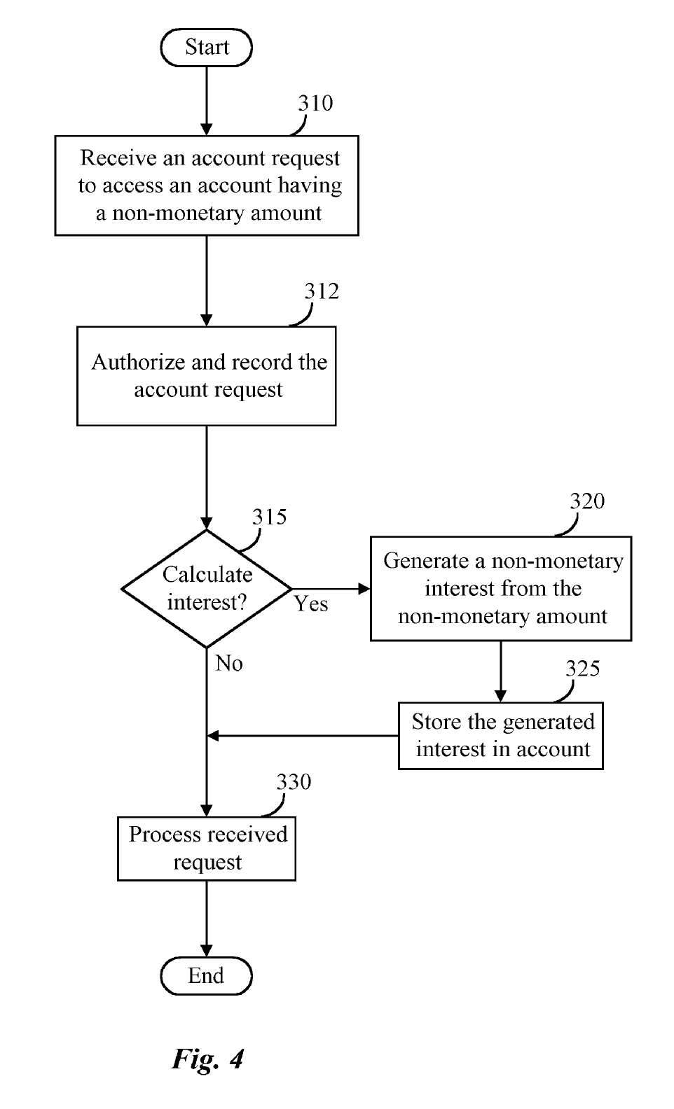

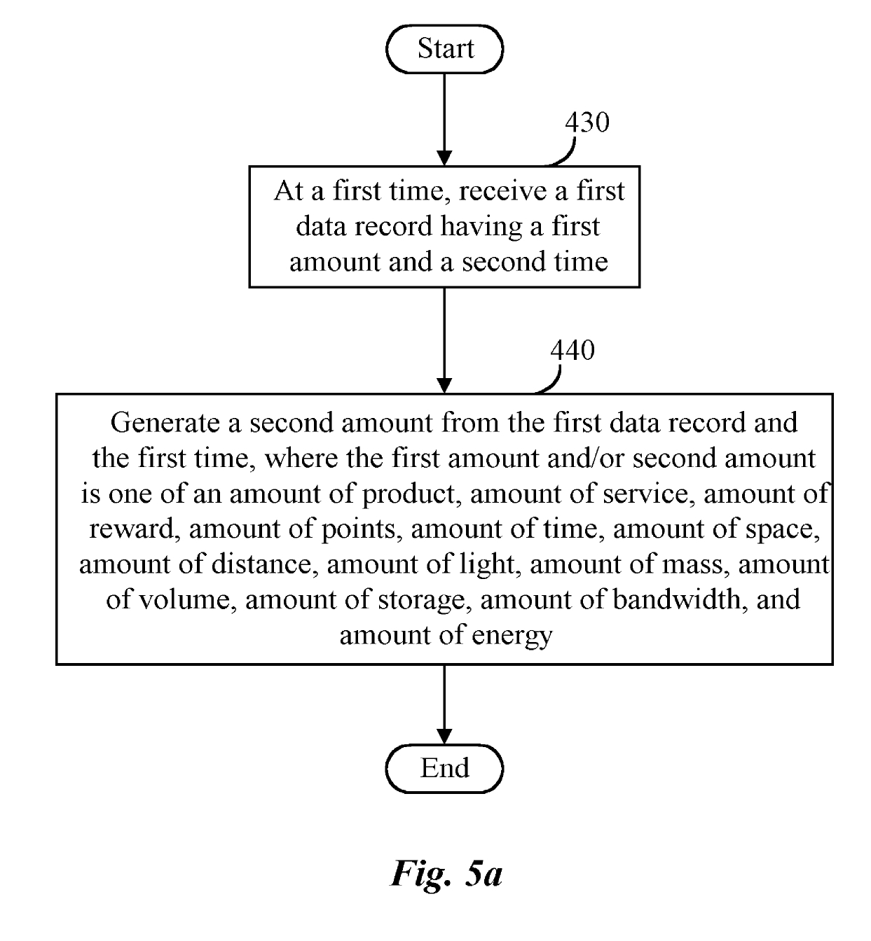

FIG. 4 is a flow chart illustrating the steps performed for receiving a request to access an account in accordance with the present invention. When a request to access an account having a non-monetary amount is received in step 310, the account request can then be authorized and recorded in step 312. The authorization can include verifying a PIN code/password from a client account database 158 and/or consulting an authorization database 154. After successful authorization, it can then be determined whether an interest is calculated in step 315. When it is determined that an interest is calculated, then a non-monetary interest from the non-monetary amount can be generated in step 320 with the generated account interest stored in the account database at step 325. After interest is calculated and stored or when it determined that interest is not to be calculated, the received request can then be processed in step 330.

A computer program product can be made to enable a computing device to execute a program that perform any of the above method steps. The product can take the form of a browser plug-in or any script adapted to selectively determine whether interest is to be calculated during an request or transaction. The product can be designed and distributed as a Dynamic Link Library (DLL), Application Programming Interface (API), CGI script, JAVA Applet, Active Server Page, and the like for the purpose of enabling account providers with the ability to add more value out of existing account programs. For instance, a company managing an airline miles program may wish to install and configure an “account interest module” for the purpose of providing earned interest in the form of additional miles to only qualified or authorized account holders such as to only “platinum” members.

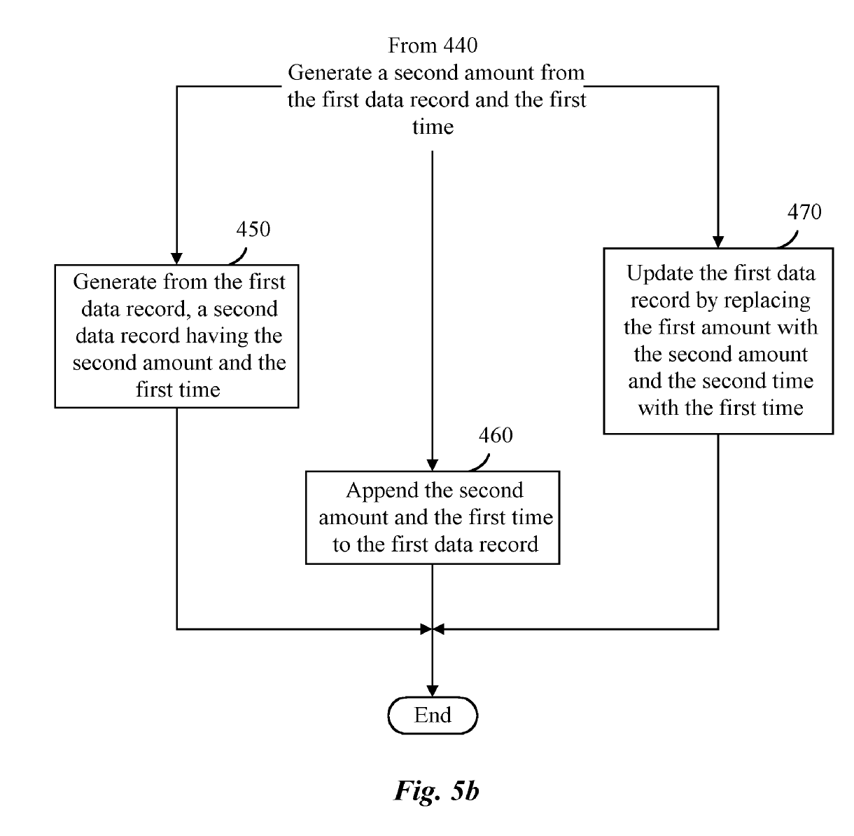

FIG. 5a is a flow chart illustrating the steps performed for generating an accrued amount from a data record in accordance with the present invention. When at a first time, a first data record having a first amount and a second time is received in step 430, a second amount can then be generated in step 440 from the first data record and the first time, wherein one of a first amount and second amount is one of an amount of product, amount of service, amount of reward, amount of points, amount of time, amount of space, amount of distance, amount of light, amount of mass, amount of volume, amount of storage, amount of bandwidth, and amount of energy.

FIG. 5b is a flow chart illustrating the steps performed for generating a new data record having an accrued amount in accordance with the present invention. When the second amount is generated (step 440) from the first data record and the first time, where one of a first amount and second amount is one of an amount of product, amount of service, amount of reward, amount of points, amount of time, amount of space, amount of distance, amount of light, amount of mass, amount of volume, amount of storage, amount of bandwidth, and amount of energy, at least one of the following actions can then be performed.

For instance, when the second amount is generated (step 440), a second data record having the second amount and the first time can then be generated in step 450 from the first data record, or the second amount and the first time can be appended in step 460 to the first data record, or the first data record can be updated in step 470 by replacing the first amount with the second amount and the second time with the first time. Whenever a data record is accessed from the account holder database 158, a new data record can be created (step 450), an existing data record can be appended (step 460) or an existing data record can be overwritten or replaced (step 470).

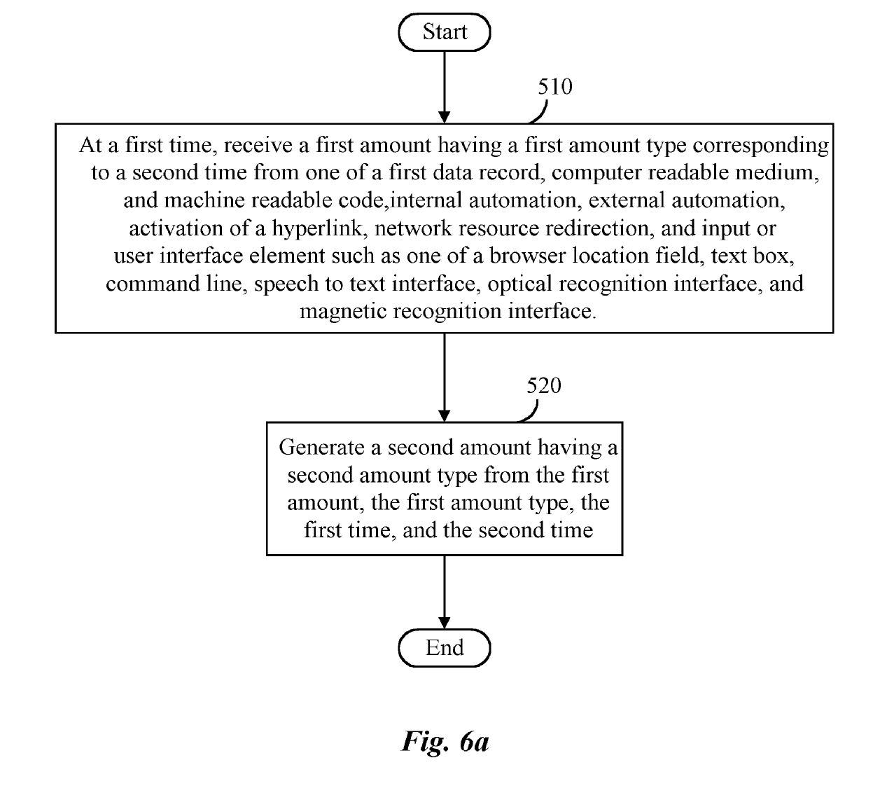

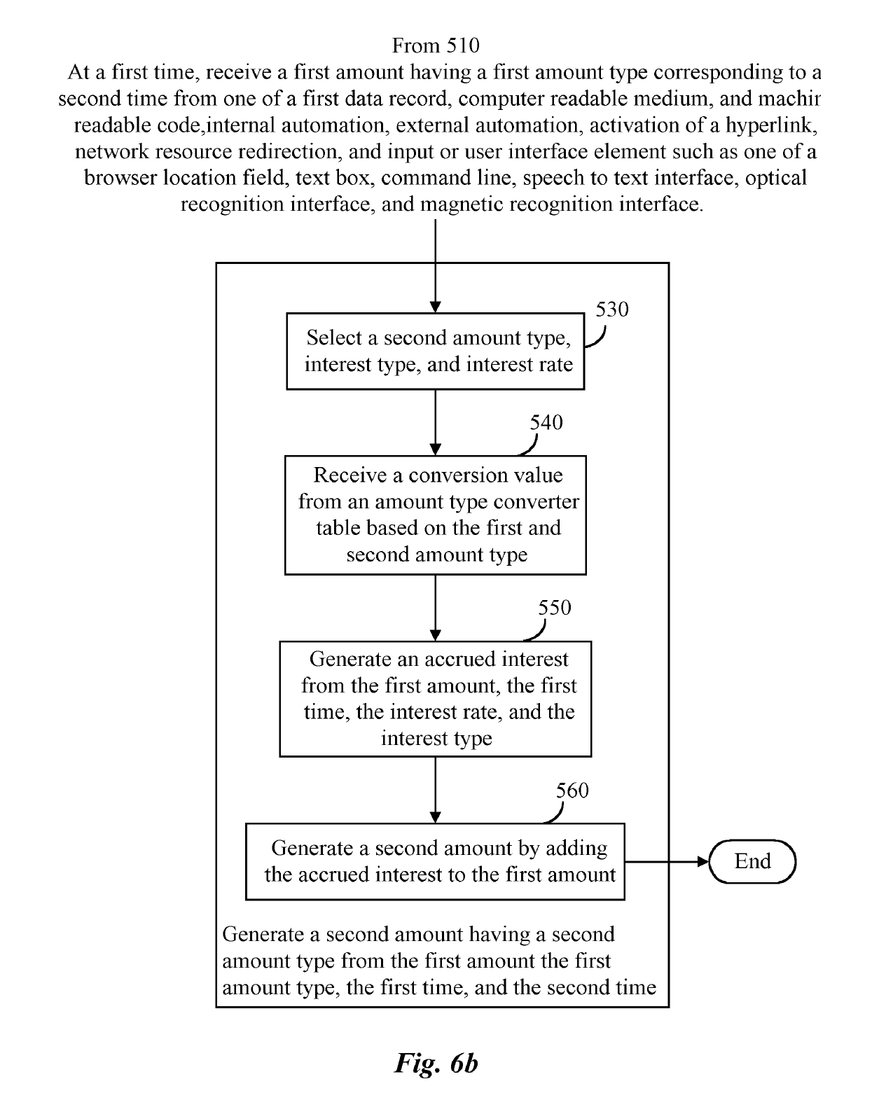

FIG. 6a is a flow chart illustrating the steps performed when receiving amount related information from a variety of input sources in accordance with the present invention. When at a first time, a first amount having a first amount type corresponding to a second time is received in step 510 from one of a input, first data record, computer readable medium, machine readable code, internal automation, external automation, activation of a hyperlink, network resource redirection, and user interface element such as one of a browser location field, text box, command line, speech to text interface, optical recognition interface, and magnetic recognition interface, a second amount having a second amount type can then be generated in step 520 from the first amount, the first amount type, the first time, and the second time.

FIG. 6b is a flow chart illustrating the steps performed for generating an interest in accordance with the present invention. When a second amount having a second amount type is generated (step 520), further steps can include selecting in step 530 a second amount type, interest type, and interest rate. A conversion value can then be accessed in step 540 from an amount type converter table based on the first and second amount type. An accrued interest can then be generated in step 550 from the first amount, the first time, the interest rate, and the interest type. The second amount can then be calculated/generated in step 560 by adding the accrued interest to the first amount.

The invention is by no means limited to interest on an amount of time and can also be applied to other amount types such as an amount of product, amount of service, amount of reward, amount of points, amount of time, amount of space, amount of distance, amount of light, amount of mass, amount of volume, amount of storage, amount of bandwidth, and amount of energy. The first non-monetary amount and the first time may be received from one of a first data record, computer readable medium (e.g., smart card, magnetic card having data bearing tracks, etc.), and machine-readable code. A first non-monetary amount, first time, and second time can be inputted from a user interface element such as a browser location field, text box, command line, speech to text interface, optical recognition interface, and magnetic recognition interface.

The non-monetary account may be one of the group consisting of a prepaid account, checking account, savings account, investment account, retirement account, credit account, and debit account that issued from one of a bank and account provider. The account provider may be one of a card provider, subscription provider, service provider, utility provider, and phone provider. The amount of time between a first time and a second time can correspond to one of a billing period and interest period. The first amount can be considered a principal and a second amount considered an interest added to the principal. The interest may be calculated from a fixed or variable interest rate as a simple interest, compound interest, or continuous interest. The interest can be escrowed, exchanged, bought, sold, converted, assigned, and invested, etc. via further specified transaction types (not shown).

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

I claim:

1. An account statement comprising: a date; and an account balance corresponding to said date wherein at least a portion of said account balance includes an account interest and one of an account balance and account interest is representative of an amount that is not legal tender.

2. The account statement, as set forth in claim 1, further including an account statement provider sending the account statement to an account holder of the account statement.

3. The account statement, as set forth in claim 1, further including an account holder requesting the account statement from an account statement provider.

4. The account statement, as set forth in claim 1, wherein the amount that is not legal tender is selected from a group consisting of an amount of product, amount of service, amount of reward, amount of points, amount of time, amount of space, amount of distance, amount of light, amount of mass, amount of volume, amount of storage, amount of bandwidth, and amount of energy.

5. A computer program product comprising computer readable program code stored on a computer readable medium, the program code adapted to one of a generate, store, access, create, update, append, report, print, overwrite, send, forward, and distribute an account statement having a date and an account balance corresponding to said date wherein at least a portion of said account balance includes an account interest and one of an account balance and account interest is representative of an amount that is not legal tender.

6. In a device having access to one of a memory and storage with a program stored therein, said program adapted to generate an amount, a method comprising: receiving at a first time, a first amount corresponding to a second time; and, generating a second amount from said first amount, said first time, and said second time, wherein one of a first amount and second amount is representative of an amount that is not legal tender.

7. The method, as set forth in claim 6, wherein said receiving said first amount corresponding to said second time includes receiving said first amount corresponding to said second time from one of a first data record, computer readable medium, machine readable code, internal automation, external automation, activation of a hyperlink, network resource redirection, and input.

8. The method, as set forth in claim 7, further including updating said first data record by replacing said first amount with said second amount and said second time with said first time.

9. The method, as set forth in claim 7, further including appending said second amount and said first time to said first data record.

10. The method, as set forth in claim 7, further including generating from said first data record, a second data record having said second amount and said first time.

11. The method, as set forth in claim 10, wherein one of a first data record, second data record, input, computer readable medium, and machine readable code corresponds to an account.

12. The method, as set forth in claim 11, wherein said account is one of the group consisting of a membership account, reward account, prepaid account, checking account, savings account, investment account, retirement account, credit account, and debit account.

13. The method, as set forth in claim 11, wherein said account is issued from one of a bank and account provider.

14. The method, as set forth in claim 13, wherein said account provider is one of a card provider, subscription provider, service provider, utility provider, and phone provider.

15. The method, as set forth in claim 7, wherein said receiving said one of a first amount, first time, and second time from input includes inputting said one of a first amount, first time, and second time from a user interface element.

16. The method, as set forth in claim 15, wherein said inputting said one of a first amount, first time, and second time from a user interface element further includes inputting said one of a first amount, first time, and second time into one of a browser location field, text box, command line, speech to text interface, optical recognition interface, and magnetic recognition interface.

17. The method, as set forth in claim 6, wherein said first amount is a principal and said generating said second amount includes adding an interest to said principal.

18. The method, as set forth in claim 17, further including calculating said interest.

19. The method, as set forth in claim 18, wherein said calculating said interest includes calculating said interest from one of an interest rate and interest type.

20. The method, as set forth in claim 19, wherein said interest rate is one of the group consisting of a fixed rate and variable rate and said interest type is one of the group consisting of a simple interest, compound interest, and continuous interest.

21. The method, as set forth in claim 6, wherein the amount of time between said first time and said second time corresponds to one of a billing period and interest period.

22. The method, as set forth in claim 6, wherein said first amount is of a first amount type and said second amount is of a second amount type.

23. The method, as set forth in claim 22, wherein said generating said second amount includes consulting an amount type conversion table for converting said first amount type to said second amount type.

24. The method, as set forth in claim 6, wherein one of a first amount and second amount is one of an amount of product, amount of service, amount of reward, amount of points, amount of time, amount of space, amount of distance, amount of light, amount of mass, amount of volume, amount of storage, amount of bandwidth, and amount of energy.

25. An apparatus comprising: a processor; one of a memory and storage in operative association with said processor; means for receiving at a first time, a first amount corresponding to a second time; and, means for generating a second amount from said first amount, said first time, and said second time, wherein one of a first amount and second amount is representative of an amount that is not legal tender.

26. A computer program product comprising computer readable program code stored on a computer readable medium, the program code adapted to execute the method for receiving at a first time, a first amount corresponding to a second time, and generating a second amount from said first amount, said first time, and said second time, wherein one of a first amount and second amount is representative of an amount that is not legal tender.
